(19) United States
(12) Patent Application Publication
(10) Pub. No.: US 2012/0288112 A1
(43) Pub. Date: Nov. 15, 2012

(54) METHOD AND CONTROLLER FOR CONTROLLING NOISE OF ROTATING DEVICE

(76) Inventors: Chengpeng YANG, Shenzhen (CN); Baosheng Li, Shenzhen (CN)

(21) Appl. No.: 13/465,502

(22) Filed: May 7, 2012

Related U.S. Application Data
(63) Continuation of application No. PCT/CN2011/073822, filed on May 9, 2011.

(51) Int. Cl. G10K 11/16

(52) U.S. Cl. 381/71.8

(57) ABSTRACT

A method for controlling noise of a rotating device includes: obtaining a sound wave signal of noise generated by the rotating device, where the sound wave signal is fed back by a reference sensor; obtaining rotational speed information of the rotating device; and searching a predefined function mapping table according to the rotational speed information to obtain transfer functions; generating a sound emitting command according to the transfer functions and the sound wave signal; and sending the sound emitting command to a secondary source emitting device, so that the secondary source emitting device emits a secondary sound wave, where the secondary sound wave is used to suppress the noise generated by the rotating device.

### CROSS-REFERENCE TO RELATED APPLICATIONS

This application is a continuation of International Application No. PCT/CN2011/073822, filed on May 9, 2011, which is hereby incorporated as reference in its entirety.

### FIELD OF THE INVENTION

The present invention relates to an active noise control technology, and in particular, to a method and a controller for controlling noise of a rotating device.

### BACKGROUND OF THE INVENTION

With the improvement of the living standard and the environmental protection consciousness, people raise higher requirements on the noise emitted by devices. Noise is not only one of the indicators for admitting a product into a market, but also an important factor to differentiate the products. Due to the requirements on higher product performance and smaller size, the conventional passive de-noising technologies encounter greater challenges in terms of integration and energy efficiency in the face of intermediate-frequency and low-frequency noise control requirements. Therefore, the active noise control technology emerges. Active noise control is a technology of using a secondary source to generate a reversed-phase sound wave through a sensing-feedback mechanism, where the reversed-phase sound wave is used to cancel the sound wave of the target noise and weaken the noise. In a 100-2000 Hz band, the noise reduction contributed by the active noise control technology is up to 10-20 dBA, which avoids the large size and low energy efficiency of the passive de-noising technology applied in intermediate-frequency and low-frequency noise control.

In all active noise control technologies, the active noise control method of one-dimensional ducts is characterized by sound field analysis and simple control because the low-frequency sound wave below the cutoff frequency is propagated in the form of a plane wave. Moreover, because of the narrow and small space of one-dimensional ducts and the simple layout of secondary sources, a single channel can accomplish good de-noising effect, and the active noise control method of one-dimensional ducts is applied frequently. An active noise control system of one-dimensional ducts includes: a controller, a secondary source emitting device, a reference sensor, and an error sensor. Its working principles are as follows: The reference sensor senses the target noise according to a sensing command, and feeds back the sensed target noise to the controller; the controller processes the target noise and generates a sound emitting command, and sends the sound emitting command to the secondary source emitting device; the secondary source emitting device emits a secondary sound wave according to the sound emitting command to cancel the target noise; and the error sensor detects the cancelled noise (named as “cancelled noise”) according to the sensing command, and feeds back the cancelled noise to the controller. The controller rectifies the emitting command according to the cancelled noise, and then sends the emitting command to the secondary source emitting device. The secondary source emitting device emits a secondary sound wave according to the rectified emitting command. The process is repeated until the noise strength is reduced.

In practice, due to sound feedback and existence of background noise, the signal detected by the reference sensor actually includes: target noise, the secondary sound wave emitted by the secondary source emitting device, and background noise; the signal detected by the error sensor includes cancelled noise and background noise. When the strength of the secondary sound wave and the background noise reaches a specific value, the error of the signal received by the controller is too great or the signal is even distorted, which affects accuracy of matching between the secondary sound wave emitted by the secondary source emitting device and the target noise, and impairs the cancellation effect. Therefore, a virtual error sensor technology and a sound feedback cancellation filtering technology are applied to overcome the impact caused by the background noise and the secondary sound wave. In this implementation, the following functions are obtained beforehand and stored onto the controller: transfer function A between the reference sensor and the virtual error sensor (namely, the error sensor that exists in the process of obtaining the transfer function but does not exist in the actual noise control process), transfer function B between the controller and the virtual error sensor, and transfer function C between the controller and the secondary source emitting device; in the actual noise control process, it is assumed that an error sensor (namely, a virtual error sensor) exists, and the controller cancels the impact of the background noise and the secondary sound wave according to the three transfer functions.

When the target noise generated by a rotating device changes little, transfer functions A, B, and C change little. Transfer functions A, B, and C obtained beforehand can be used to accurately predict the target noise and the secondary sound wave at the location of the virtual error sensor and the secondary sound wave at the location of the reference sensor, so that the controller can send the sound emitting command accurately, and the sound wave at the location of the virtual error sensor is cancelled completely, which fulfills the purpose of reducing noise. However, if the target noise generated by the rotating device changes sharply, transfer functions A, B, and C change sharply, and transfer functions A, B, and C obtained previously will be inapplicable, which frustrates the purpose of reducing noise.

### SUMMARY OF THE INVENTION

Embodiments of the present invention provide a method and a controller for controlling noise of a rotating device. The method and the controller reduce the target noise of the rotating device and overcome the following disadvantage of the prior art: The noise reduction fails when the noise generated by the rotating device changes sharply.

An embodiment of the present invention provides a method for controlling noise of a rotating device, including:

obtaining a sound wave signal of noise generated by the rotating device, where the sound wave signal is fed back by a reference sensor;

obtaining rotational speed information of the rotating device;

searching a predefined function mapping table according to the rotational speed information to obtain a transfer function;

generating a sound emitting command according to the transfer function and the sound wave signal; and

sending the sound emitting command to a secondary source emitting device, so that the secondary source emitting device emits a secondary sound wave according to the sound emitting command, where the secondary sound wave is used to suppress the noise generated by the rotating device.

An embodiment of the present invention provides a controller, including:

a signal obtaining module, configured to obtain a sound wave signal of noise generated by a rotating device, where the sound wave signal is fed back by a reference sensor;

a rotational speed obtaining module, configured to obtain rotational speed information of the rotating device;

a searching module, configured to search a predefined function mapping table according to the rotational speed information to obtain transfer functions;

a first generating module, configured to generate a sound emitting command according to the transfer functions and the sound wave signal; and

a sending module, configured to send the sound emitting command to a secondary source emitting device, so that the secondary source emitting device emits a secondary sound wave, where the secondary sound wave is used to suppress the noise generated by the rotating device.

With the method and the controller for controlling noise of a rotating device in the embodiments of the present invention, a function mapping table is generated beforehand, the rotational speed information of the rotating device is obtained in the noise reduction process, transfer functions suitable for the rotational speed information are obtained by searching the function mapping table according to the rotational speed information, a sound emitting command is generated according to the obtained transfer functions, and a secondary source emitting device is controlled to emit a secondary sound wave to cancel the target noise of the rotating device, thereby fulfilling the purpose of reducing noise. In the embodiments of the present invention, the transfer functions suitable for the target noise are obtained by searching the function mapping table according to the rotational speed information of the rotating device, so that the problem in the prior art is solved, the impact caused by the volume of noise generated by the rotating device is overcome, and the purpose of reducing noise is fulfilled.

### BRIEF DESCRIPTION OF THE DRAWINGS

To make the technical solutions in the embodiments of the present invention or the prior art clearer, the accompanying drawings used in the description of the embodiments of the present invention or the prior art are briefly described hereunder. Obviously, the accompanying drawings illustrate some embodiments of the present invention, and persons of ordinary skill in the art can derive other drawings from such accompanying drawings without making any creative effort.

FIG. 1 is a schematic structural diagram of an active noise control system of one-dimensional ducts according to each embodiment of the present invention;

FIG. 2 is a flowchart of a method for controlling noise of a rotating device according to an embodiment of the present invention;

FIG. 3 is a flowchart of a method for controlling noise of a rotating device according to another embodiment of the present invention;

FIG. 4A to FIG. 4C are schematic diagrams illustrating how to obtain transfer functions corresponding to rotational speed information according to an embodiment of the present invention;

FIG. 4D is a flowchart of an implementation way of step 201 according to an embodiment of the present invention;

FIG. 4E is a flowchart of an implementation way of step 201 according to another embodiment of the present invention;

FIG. 5 is a schematic structural diagram of a controller according to an embodiment of the present invention; and

FIG. 6 is a schematic structural diagram of a controller according to another embodiment of the present invention.

### DETAILED DESCRIPTION OF THE EMBODIMENTS

In order to make the objectives, technical solutions, and advantages of the embodiments of the present invention more comprehensible, the technical solutions of the embodiments of the present invention are described clearly and completely in the following. Obviously, the embodiments to be described are only some, rather than all embodiments of the present invention. All other embodiments, which can be derived by persons of ordinary skill in the art from the embodiments of the present invention without making any creative effort, shall fall within the protection scope of the present invention.

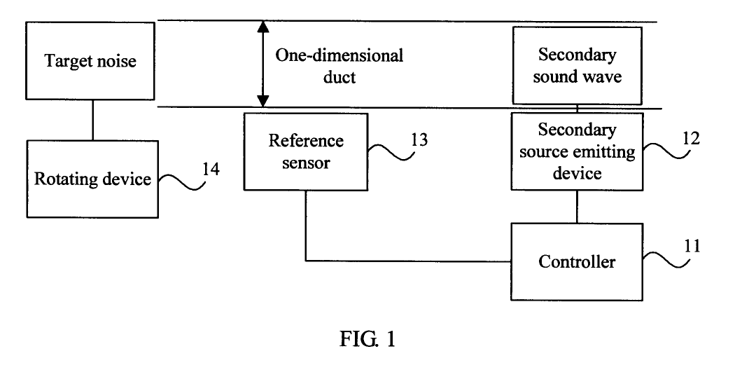

FIG. 1 is a schematic structural diagram of an active noise control system of one-dimensional ducts according to each embodiment of the present invention. As shown in FIG. 1, the system in this embodiment includes a controller 11, a secondary source emitting device 12, a reference sensor 13, and a rotating device 14; the controller 11 is connected to the secondary source emitting device 12 and the reference sensor 13. The rotating device 14 may be any device that works in the form of rotating or revolving, and is preferably a device that rotates or revolves to drive fluids, such as a fan or water pump. The rotating device 14 is a noise source. The noise generated by the rotating device is called target noise. The reference sensor 13 is designed for detecting the noise generated by the rotating device 14 (namely, target noise). However, due to existence of sound reflection and background noise, the signal detected by the reference sensor 13 is a sound wave signal mingled with the target noise, a secondary sound wave, and background noise. The reference sensor 13 is further configured to feed back the detected sound wave signal to the controller 11. The controller 11 is configured to process the sound wave signal, generate a sound emitting command, and send the sound emitting command to the secondary source emitting device 12. The secondary source emitting device 12 is configured to receive the sound emitting command sent by the controller 11 and emit a secondary sound wave to cancel the target noise.

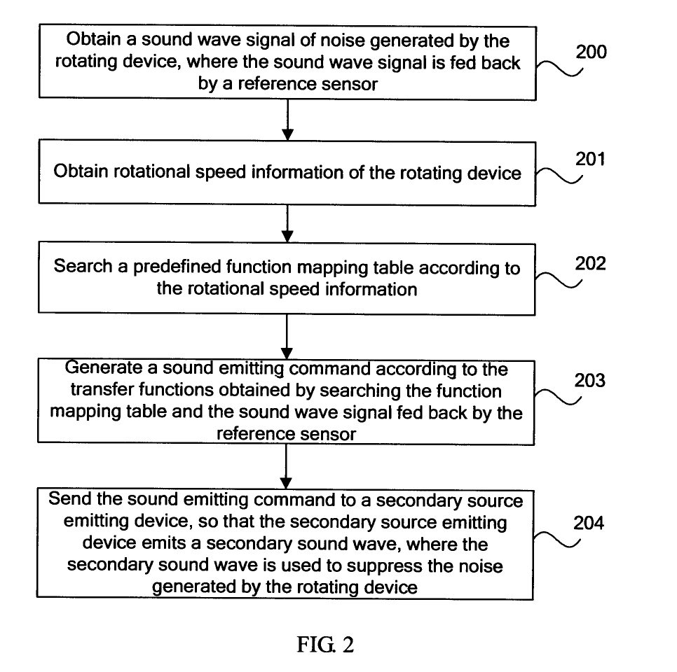

FIG. 2 is a flowchart of a method for controlling noise of a rotating device according to an embodiment of the present invention. As shown in FIG. 2, the method in this embodiment includes the following steps:

Step 200: Obtain a sound wave signal of noise generated by the rotating device, where the sound wave signal is fed back by a reference sensor.

Specifically, the reference sensor 13 detects the sound wave signal of noise generated by the rotating device 14, and feeds back the signal to the controller 11. The sound wave signal is mingled with the noise generated by the rotating device 14 (namely, target noise), a secondary sound wave, and background noise.

Step 201: Obtain rotational speed information of the rotating device.

The rotational speed information of the rotating device 14 mainly refers to information related to rotational speeds, for example, the number of rotation times in a unit time. The rotational speed information may vary according to the type of the rotating device 14. For example, if the rotating device 14 is a fan, the rotational speed information refers to the number of rotation times of the motor of the fan in a unit time; for another example, if the rotating device 14 is a water pump, the rotational speed information refers to the number of rotation times of the motor of the pump in a unit time. Each rotating device may have different rotational speeds. One rotational speed corresponds to a type of rotational speed information. The rotating device generates different target noise when it runs at different speeds. For example, when a fan runs at a speed of 2000 rotation times per minute, it is assumed that the sound pressure level of generated target noise is 30 dBA, the sound pressure level of the target noise generated when this type of fan runs 4000 rotation times per minute is 45 dBA. That is, when the rotational speed of the fan is doubled, the corresponding sound energy increases about 31.6 times. It can be seen that, the size of the target noise generated by the rotating device 14 depends on its rotational speed information. Generally, the rotational speed of the rotating device 14 is faster, and its generated target noise is larger.

To improve the effect of cancelling the target noise, the controller 11 obtains the rotational speed information of the rotating device. In this way, a sound emitting command is generated according to the rotational speed information, and the target noise can be better cancelled.

Step 202: Search a predefined function mapping table according to the rotational speed information to obtain transfer functions.

For the active noise control system of one-dimensional ducts shown in FIG. 1, the transfer functions in this embodiment mainly include: transfer function A between the reference sensor 13 and a virtual error sensor, transfer function B between the controller 11 and the virtual error sensor (transfer function B is mainly used to express the function relationship between the sound emitting command generated by the controller 11 and a sound wave signal at the location of the virtual error sensor), and transfer function C between the controller 11 and the reference sensor 13 (transfer function C is mainly used to express the function relationship between the sound emitting command generated by the controller 11 and a sound wave signal at the location of the reference sensor 13). The transfer function may vary according to the type of the active noise control system.

The function mapping table stores multiple common types of rotational speed information of the rotating device and the transfer functions corresponding to each type of rotational speed information. As shown in Table 1, the function mapping table stores n types of rotational speed information, and each type of rotational speed information corresponds to different transfer functions: transfer function A, transfer function B, and transfer function C. Specifically, the controller 11 searches the function mapping table according to the rotational speed information to obtain the transfer functions corresponding to the rotational speed information. In this embodiment, the function mapping table is generated beforehand. In addition, the function mapping table may be stored on the controller 11, or may also be stored on another server and allowed to be searched by the controller 11.

TABLE 1

| Type of Rotational | Transfer | Transfer | Transfer |
|---|---|---|---|
| Speed Information | Function A | Function B | Function C |
| Type 1 | A1 | B1 | C1 |
| Type 2 | A2 | B2 | C2 |
| Type 3 | A3 | B3 | C3 |
| Type 4 | A4 | B4 | C4 |
| . . . | . . . | . . . | . . . |
| Type n | An | Bn | Cn |

Step 203: Generate a sound emitting command according to the transfer functions obtained by searching the function mapping table and the sound wave signal fed back by the reference sensor.

Specifically, the controller 11 searches the function mapping table to obtain transfer function A, transfer function B, and transfer function C that are corresponding to the rotational speed information, processes the sound wave signal fed back by the reference sensor 13 according to the obtained transfer function A, transfer function B, and transfer function C, and generates a sound emitting command according to a processing result.

Step 204: Send the sound emitting command to a secondary source emitting device, so that the secondary source emitting device emits a secondary sound wave, where the secondary sound wave is used to suppress the noise generated by the rotating device.

Specifically, after generating the sound emitting command, the controller 11 sends the generated sound emitting command to the secondary source emitting device 12. The secondary source emitting device 12 emits a secondary sound wave according to the sound emitting command. The secondary sound wave is propagated toward the reference sensor 13 to cancel the target noise, so as to fulfilling the purpose of suppressing the target noise.

With the method for controlling noise of the rotating device in this embodiment, the controller obtains the rotational speed information of the rotating device, determines the transfer functions suitable for the target noise subject to the rotational speed information according to the rotational speed information, processes, according to the obtained transfer functions, the sound wave signal fed back by the reference sensor, and generates a sound emitting command, so that the secondary source emitting device emits a secondary sound wave that has a reversed phase and equivalent intensity relative to the target noise, to cancel the target noise, thereby fulfilling the purpose of reducing noise. The function mapping table provided in this embodiment stores the transfer functions corresponding to multiple types of rotational speed information of the rotating device beforehand. In the noise control process, the corresponding transfer functions are obtained according to the actual rotational speed of the rotating device, which solves the following problem in the prior art: The same transfer function applied in the prior art is unable to cancel the target noise that is sharply different from the target noise used for obtaining the transfer functions, and is unable to fulfill the purpose of reducing noise. The noise reduction in this embodiment is not limited by the size of the target noise any more, and the noise is reduced in a real sense.

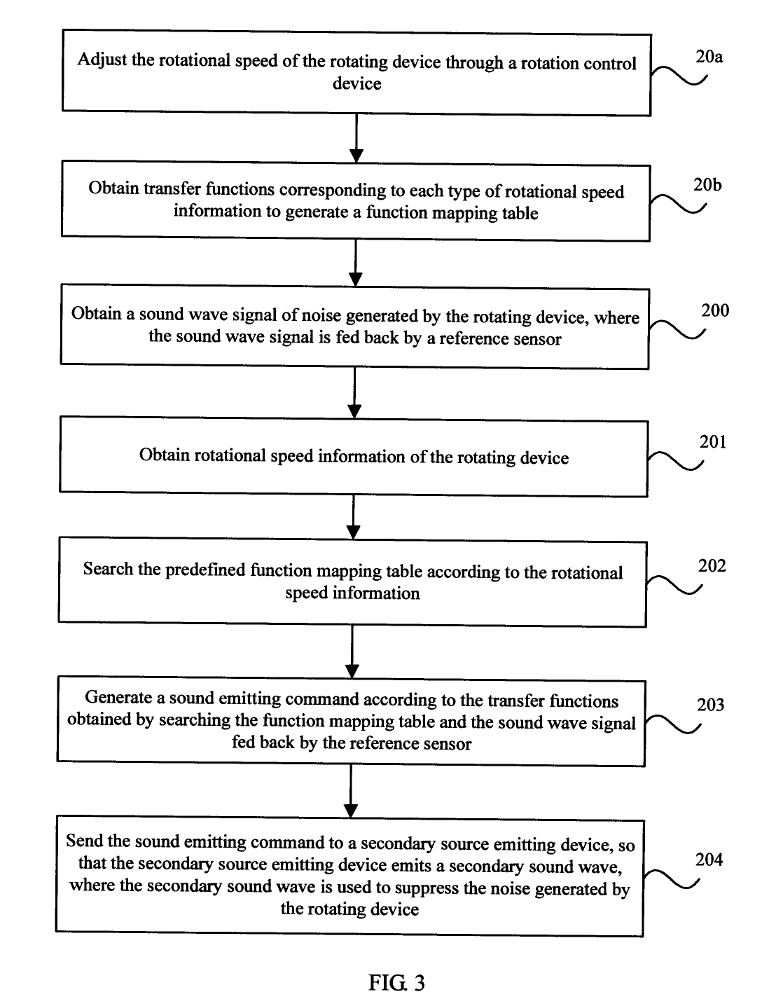

Further, as shown in FIG. 3, the method for controlling noise of the rotating device in this embodiment includes a step of generating a function mapping table before step 202. The step of generating the function mapping table specifically includes the following:

Step 20a: Adjust the rotational speed of the rotating device through a rotation control device.

In this embodiment, the rotation control device may serve as a functional component of the rotating device 14 and be arranged in the rotating device 14, or may be independent of the rotating device 14 but is connected to the rotating device 14. In this embodiment, the rotation control device is configured to send a rotational speed adjustment signal to the rotation control device to adjust the rotational speed of the rotating device 14, so as to fulfill the purpose of adjusting the rotational speed.

Step 20b: Obtain transfer functions corresponding to each type of rotational speed information to generate a function mapping table.

Taking the system in FIG. 1 as an example, the transfer functions generated in this embodiment include: transfer function A, transfer function B, and transfer function C. If the rotating device has n types of rotational speed information, the generated function mapping table is shown in Table 1. The following describes in detail the process of obtaining the transfer functions, by taking the scenario of obtaining transfer functions corresponding to one type of rotational speed information as an example.

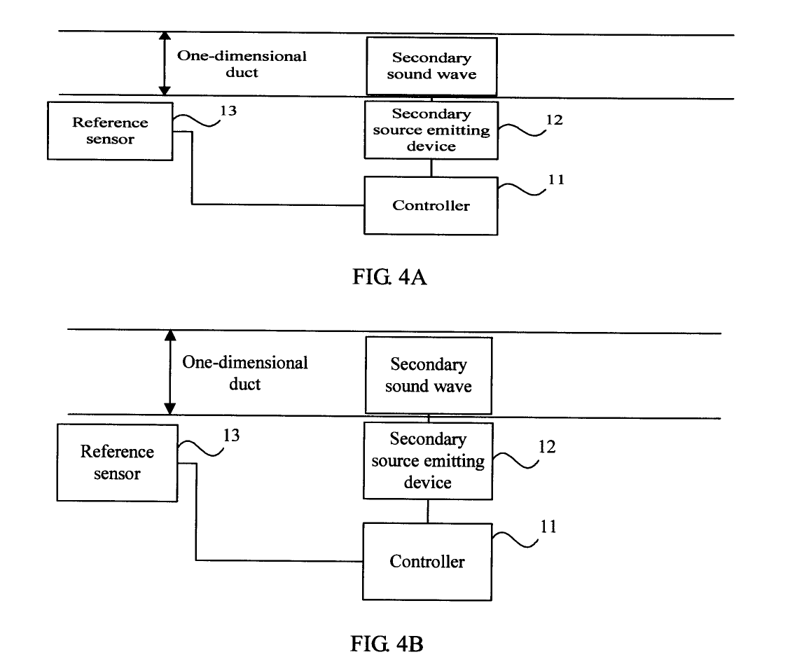

In this embodiment, the working principle of a virtual error sensor is applied. That is, in the obtaining process, an error sensor 15 is arranged, and is temporarily located far away from the reference sensor 13, as shown in FIG. 4A. A test is performed in an environment with low background noise (it needs to ensure that the background noise can be ignored), and the secondary source emitting device 12 is shut down (not illustrated in FIG. 4A). In this case, only the target noise generated by the rotating device 14 according to certain rotational speed information set by the rotation control device exists, and the target noise is propagated to the error sensor 15. At this time, the reference sensor 13 and the error sensor 15 each may detect a sound wave signal, and each feed back the signal to the controller 11. The controller 11 calculates transfer function A between the reference sensor 11 and the error sensor 15 according to the sound wave signal fed back by each of the reference sensor 13 and the error sensor 15, where transfer function A corresponds to the target noise subject to the rotational speed information.

Subsequently, as shown in FIG. 4B, the test environment is changed. In the environment, the rotating device 14 is shut down (FIG. 4B shows neither the rotating device 14 nor the reference sensor 13), and the background noise is low (it ensures that the background noise can be ignored). The controller 11 sends a sound emitting command to the secondary source emitting device 12. In this case, the secondary source emitting device 12 may emit a secondary sound wave according to the sound emitting command. The secondary sound wave may be propagated toward the error sensor 15. The error sensor 15 may detect a sound wave signal (mainly, a secondary sound wave), and feed it back to the controller 11. The controller 11 calculates transfer function B between the controller 11 and the error sensor 15 according to the emitted sound emitting command and the sound wave signal that is fed back by the error sensor 15.

Subsequently, as shown in FIG. 4C, the test goes on in an environment with the rotating device 14 being shut down (FIG. 4C shows neither the rotating device 14 nor the error sensor 15) and with low background noise (it ensures that the background noise can be ignored). In this case, the controller 11 sends a sound emitting command to the secondary source emitting device 12, and the secondary source emitting device 12 may emit a secondary sound wave according to the sound emitting command. The secondary sound wave may be propagated toward the reference sensor 13. The reference sensor 13 may detect a sound wave signal (mainly, a secondary sound wave), and feeds it back to the controller 11. The controller 11 calculates transfer function C between the controller 11 and the reference sensor 13 according to the emitted sound emitting command and the sound wave signal that is fed back by the reference sensor 13.

The transfer function B and transfer function C may be obtained by adopting the same test process. The order of obtaining the transfer functions is not limited to the order exemplified above, and may be arbitrary.

When the rotation control device sends a rotational speed adjustment signal and finishes controlling the rotating device 14 to adjust the rotational speed, the target noise subject to the rotational speed information is tested once, so as to obtain transfer function A between the reference sensor 11 and the error sensor 15, where transfer function A corresponds to the target noise subject to the rotational speed information. The process of obtaining transfer function B and transfer function C is independent of the target noise. Therefore, transfer function B and transfer function C may be re-obtained again, or may be not obtained any more (namely, obtained only once).

After the target noise subject to all common rotational speed information of the rotating device 14 is tested, a function mapping table shown in Table 1 may be generated according to test results.

Based on the description above, this embodiment provides a detailed implementation way of step 203: When the rotating device 14 generates target noise, the controller 11 sends a sound emitting command to the secondary source emitting device 12, and the secondary source emitting device 12 emits a secondary sound wave. In this environment, the reference sensor 13 detects the sound wave signal (including the target noise, secondary sound wave, and background noise), the controller 11 calculates the secondary sound wave at the location of the reference sensor 13 according to transfer function C and a previous sound emitting command, then obtains the target noise by performing subtraction between the sound wave signal fed back by the reference sensor 13 and the calculated secondary sound wave. And then, a target sound wave signal at the location of an imaginary error sensor (namely, a virtual error sensor) is calculated by applying transfer function A and the obtained target noise, where the target noise propagates to the location. Afterward, the secondary sound wave that needs to be emitted by the secondary source emitting device 12 is calculated by applying transfer function B and the calculated target sound wave signal, and a sound emitting command corresponding to the secondary sound wave is generated. The sound emitting command is provided to the secondary source emitting device 12, and the secondary source emitting device 12 emits a secondary sound wave according to the sound emitting command. The secondary sound wave is propagated to the location of the presumed error sensor to cancel the target sound wave signal at this location, thereby fulfilling the purpose of reducing noise.

Further, as shown in FIG. 4D, this embodiment provides a detailed implementation way of step 201, which includes the following steps:

Step 201a: Receive a rotational speed adjustment signal sent by a rotation control device.

Specifically, the rotation control device sends a rotational speed adjustment signal to the rotating device, and the rotating device adjusts a rotational speed according to the rotational speed adjustment signal. For example, the rotational speed of a fan is adjusted from level 1 to level 2 according to the rotational speed adjustment signal sent by the rotation control device. Afterward, the rotating device returns adjustment success information to the rotation control device; after receiving the adjustment success information, the rotation control device sends a rotational speed adjustment signal to the controller to indicate the adjusted rotational speed information of the rotating device to the controller.

In addition, the rotation control device may send the rotational speed adjustment signal to the controller directly after sending the rotational speed adjustment signal to the rotating device.

The rotation control device may be set independently of both the rotating device and the controller, but connected to both the rotating device and the controller. In addition, the rotation control device may also be integrated with the controller and connected to the rotating device and the controller.

Step 201b: Obtain the rotational speed information according to the rotational speed adjustment signal.

Specifically, the controller parses the rotational speed adjustment signal to obtain rotational speed information. Afterward, the controller continues to obtain transfer functions according to the obtained rotational speed information and perform subsequent operations.

In this implementation way, it is only required to connect the rotation control device to the controller and enable the rotation control device to send a rotational speed adjustment signal to the controller. The implementation way is simple, requires few changes to the existing devices, and has the advantages of good practicability and low cost.

Further, as shown in FIG. 4E, this embodiment provides another detailed implementation way of step 201, which includes the following steps:

Step 201c: Obtain a signal feature of target noise according to the sound wave signal fed back by a reference sensor.

Specifically, the controller 11 processes the sound wave signal to obtain the signal feature of the target noise. The signal feature of the target noise may refer to the signal intensity of the target noise, such as a sound intensity level or sound pressure level; or refer to the spectrum feature of the target noise, such as the peak of the target noise (namely, the peak of rotation noise known in the art). The controller 11 processes the sound wave signal in one of the following scenarios:

Scenario 1: If a sound wave signal received by the controller 11 is sharply different from a previous sound wave signal received by the controller 11, it may be determined that the impact caused by the background noise and the secondary sound wave is small. Therefore, the controller 11 may use the received sound wave signal as the target noise directly.

For example, the controller 11 may compare the noise pressure level or peak of a sound wave signal or the like with that of a previous sound wave signal to identify the difference between the two sound wave signals.

Scenario 2: If the difference between a sound wave signal received by the controller 11 and a previous sound wave signal received by the controller 11 is not great enough to ignore the background noise and the secondary sound wave, the controller 11 calculates, according to a current sound emitting command and the transfer function C corresponding to the current sound emitting command, the secondary sound wave at a location where the reference sensor 13 locates after the secondary sound wave is transmitted to the location, and then obtains the target noise by performing subtraction between the sound wave signal fed back by the reference sensor 13 and the calculated secondary sound wave.

Step 201d: Search a predefined rotational speed mapping table according to the signal feature of the target noise to obtain rotational speed information.

Multiple rotational speedcommon types of rotational speed information of the rotating device 14 and the signal feature of target noise subject to each type of rotational speed information are stored in the rotational speed mapping table. The rotational speed mapping table is generated and stored beforehand. The table may be stored on the controller 11 directly, or may be stored on another server and is allowed to be searched by the controller 11.

Specifically, after obtaining the signal feature of the target noise, the controller 11 may obtain the corresponding rotational speed information by searching the rotational speed mapping table. Afterward, the controller 11 continues to obtain transfer functions according to the rotational speed information and perform subsequent operations.

Before this implementation is implemented, the operation of generating a rotational speed mapping table may further be included. Specifically, the rotation control device may be used to adjust the rotational speed of the rotating device 14, and then the reference sensor 13 detects target noise to obtain the signal feature of target noise subject to each type of rotational speed information, so as to generate a rotational speed mapping table. For example, Table 2 shows the corresponding relationship between each type of rotational speed information and the signal feature of target noise when the rotating device has n types of rotational speed information.

TABLE 2

| Type of Rotational | Signal Feature X |
|---|---|
| Speed Information | of Target Noise |
| Type 1 | X1 |
| Type 2 | X2 |
| Type 3 | X3 |
| Type 4 | X4 |
| . . . | . . . |
| Type n | Xn |

This implementation has the advantages of good practicability and low cost.

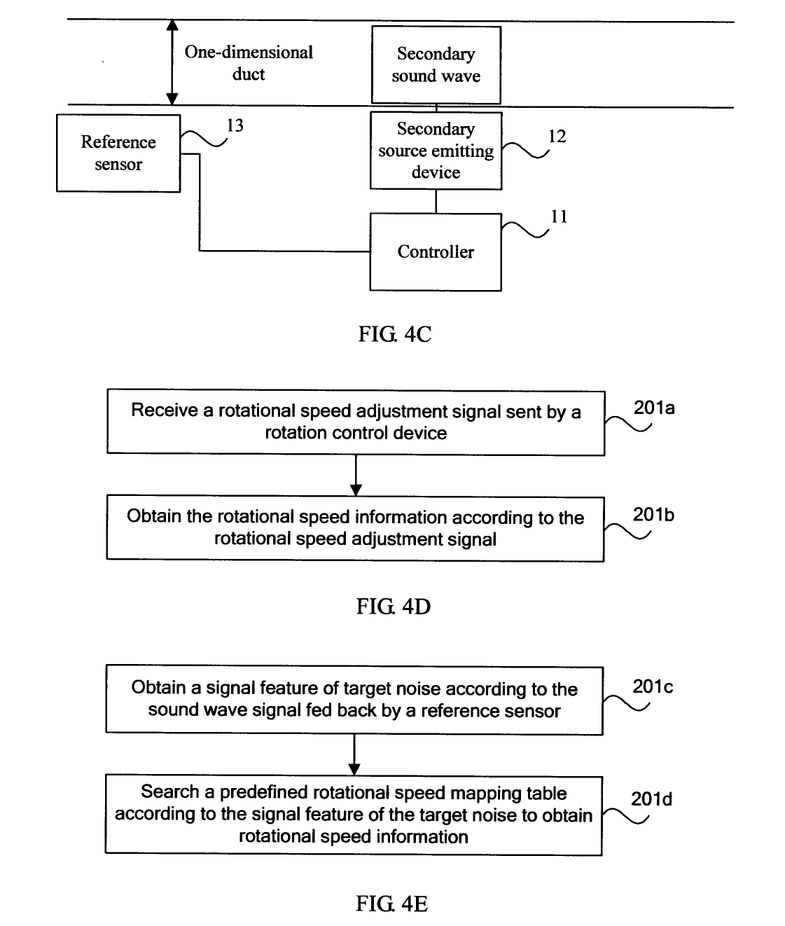

FIG. 5 is a schematic structural diagram of a controller according to an embodiment of the present invention. As shown in FIG. 5, the controller in this embodiment includes a signal obtaining module 50, a rotational speed obtaining module 51, a searching module 52, a first generating module 53, and a sending module 54.

The signal obtaining module 50 is configured to obtain a sound wave signal of noise generated by a rotating device, where the sound wave signal is fed back by a reference sensor; the rotational speed obtaining module 51 is configured to obtain rotational speed information of the rotating device; the searching module 52 is connected to the rotational speed obtaining module 51, and is configured to search a predefined function mapping table according to the rotational speed information to obtain transfer functions, and provide the obtained transfer functions for the first generating module 53; the first generating module 53 is connected to the signal obtaining module 50 and the searching module 52, and is configured to generate a sound emitting command according to the transfer functions obtained by searching the function mapping table and the sound wave signal fed back by the reference sensor; and the sending module 54 is connected to the first generating module 53, and is configured to send the sound emitting command to a secondary source emitting device, so that the secondary source emitting device emits a secondary sound wave, where the secondary sound wave is used to suppress the noise generated by the rotating device. The controller may include a storage module (not illustrated) which is configured to store the function mapping table for being searched by the searching module 52. In addition, for ease of implementing the controller, the function mapping table may also be stored on another server and is allowed to be searched by the searching module 52 of the controller.

The functional modules of the controller in this embodiment may be configured to execute the process of the method shown in FIG. 2. For the detailed working principle of the modules, reference can be made to the description in the method embodiment, and details are not repeated herein.

The controller in this embodiment obtains the rotational speed information of the rotating device, determines the transfer functions suitable for the target noise subject to the rotational speed information by searching the function mapping table according to the rotational speed information, processes, according to the obtained transfer functions, the sound wave signal fed back by the reference sensor, and generates a sound emitting command, so that the secondary source emitting device emits a secondary sound wave that has a reversed phase and equivalent intensity relative to the target noise, thereby solving the following problem in the prior art: The same transfer function applied in the prior art is unable to cancel the target noise that is sharply different from the target noise used for obtaining the transfer functions, and is unable to fulfill the purpose of reducing noise. The noise reduction in this embodiment is not limited by the size of the target noise any more, and the noise is reduced in a real sense.

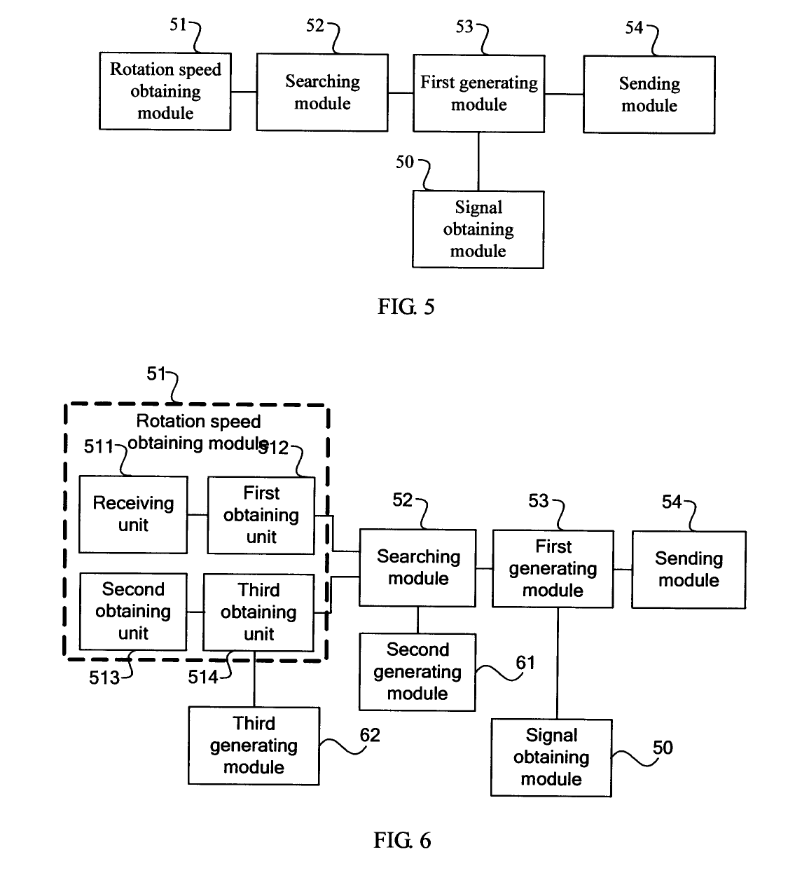

FIG. 6 is a schematic structural diagram of a controller according to another embodiment of the present invention. This embodiment is implemented based on the embodiment shown in FIG. 5. As shown in FIG. 6, the rotational speed obtaining module 51 in this embodiment includes: a receiving unit 511 and a first obtaining unit 512.

Specifically, the receiving unit 511 is configured to receive a rotational speed adjustment signal sent by a rotation control device. The first obtaining unit 512 is connected to the receiving unit 511, and is configured to obtain rotational speed information according to the rotational speed adjustment signal.

As shown in FIG. 6, the rotational speed obtaining module 51 in this embodiment may have another implementation structure, which includes a second obtaining unit 513 and a third obtaining unit 514.

Specifically, the second obtaining unit 513 is configured to obtain a signal feature of target noise according to the sound wave signal fed back by a reference sensor. The third obtaining unit 514 is connected to the second obtaining unit 513, and is configured to search a predefined rotational speed mapping table according to the signal feature of the target noise to obtain rotational speed information. The signal feature of the target noise may refer to the signal strength of the target noise, such as a sound strength level or sound pressure level; or refer to the spectrum feature of the target noise, such as the peak of the target noise (namely, the peak of rotation noise known in the art).

The functional units of the rotational speed obtaining module 51 may be configured to execute the process of the implementation way of step 101 provided in the foregoing method embodiment. For the working principle of the module, reference can be made to the description in the method embodiment, and details are not repeated herein.

Further, as shown in FIG. 6, the controller in this embodiment further includes a second generating module 61. The second generating module 61 is configured to obtain transfer functions corresponding to each type of rotational speed information of the rotating device to generate a function mapping table that includes the rotational speed information and the transfer functions corresponding to the rotational speed information.

Specifically, the second generating module 61 may be a controlling unit, which is configured to control each functional module of the controller to collaborate with the rotating device, rotation control device, secondary source emitting device, reference sensor, and so on to perform a test and generate a function mapping table. For the detailed working principle of the second generating module, reference can be made to the process of generating the function mapping table in FIG. 3 and FIG. 4A to FIG. 4C, and details are not repeated herein.

Further, the controller in this embodiment further includes a third generating module 62. The third generating module 62 is configured to generate, according to the signal feature of target noise subject to each type of rotational speed information of the rotating device, a rotational speed mapping table that includes the rotational speed information and the signal feature corresponding to the rotational speed information, where the signal feature of the target noise is obtained by the reference sensor. Specifically, the third generating module 62 may also be a controlling unit, which is configured to control the rotating device, rotation control device, reference sensor, and so on to perform a test, and generate a rotational speed mapping table according to information obtained in the test. For the detailed working principle of the third generating module, reference can be made to the process of generating the rotational speed mapping table in the second implementation way of step 101, and details are not repeated herein.

In addition, when the controller obtains the rotational speed information of the rotating device through the rotation control device, the rotation control device may be integrated with the controller. For example, the rotation control device and the controller are integrated on one chip for implementation.

To sum up, the controller in the embodiment obtains the rotational speed information of the rotating device according to the predefined rotational speed mapping table or rotational speed adjustment signal, determines the transfer functions suitable for the target noise subject to the rotational speed information by searching the predefined function mapping table according to the rotational speed information, processes, according to the obtained transfer functions, the sound wave signal fed back by the reference sensor, and generates a sound emitting command, so that the secondary source emitting device emits a secondary sound wave that has a reversed phase and equivalent intensity relative to the target noise, thereby solving the following problem in the prior art: The same transfer function applied in the prior art is unable to cancel the target noise that is sharply different from the target noise used for obtaining the transfer functions, and is unable to fulfill the purpose of reducing noise. The noise reduction in the embodiment is not limited by the size of the target noise any more, and the noise is reduced in a real sense.

Persons of ordinary skill in the art should understand that all or part of the steps of the method according to the above embodiments may be implemented by a program instructing relevant hardware. The program may be stored in a computer readable storage medium. When the program runs, the program executes steps of the method specified in the above embodiments. The storage medium may be any medium capable of storing program codes, such as a ROM, RAM, magnetic disk, or CD-ROM.

Finally, it should be noted that the above embodiments are merely provided for describing the technical solutions of the present invention, but not intended to limit the present invention. Although the present invention is described in detail with reference to the forgoing embodiments, persons of ordinary skill in the art should understand that various modifications can be made to the technical solutions described in the forgoing embodiments and various variations can be made to some technical features of the technical solutions described in the forgoing embodiments, and such modifications and variations cannot cause the essence of the corresponding technical solutions to depart from the spirit and scope of the technical solutions of the embodiments of the present invention.

What is claimed is:

1. A method for controlling noise of a rotating device, comprising:
obtaining a sound wave signal of noise generated by the rotating device, wherein the sound wave signal is fed back by a reference sensor;
obtaining rotational speed information of the rotating device;
searching a predefined function mapping table according to the rotational speed information to obtain transfer functions;
generating a sound emitting command according to the transfer functions and the sound wave signal; and
sending the sound emitting command to a secondary source emitting device, the secondary source emitting device being configured to emit a secondary sound wave according to the sound emitting command, wherein the secondary sound wave is for suppressing the noise generated by the rotating device.

2. The method for controlling noise of a rotating device according to claim 1, wherein the obtaining the rotational speed information of the rotating device comprises:
receiving a rotational speed adjustment signal sent by a rotation control device, wherein the rotational speed adjustment signal is for adjusting a rotational speed of the rotating device; and
obtaining the rotational speed information according to the rotational speed adjustment signal.

3. The method for controlling noise of a rotating device according to claim 1, wherein the obtaining the rotational speed information of the rotating device comprises:
obtaining a signal feature of the noise according to the sound wave signal fed back by the reference sensor; and
searching a predefined rotational speed mapping table according to the signal feature of the noise to obtain the rotational speed information.

4. The method for controlling noise of a rotating device according to claim 1, wherein:
before the searching the predefined function mapping table according to the rotational speed information to obtain the transfer functions, the method comprises:
adjusting the rotational speed of the rotating device through the rotation control device; and
obtaining transfer functions corresponding to each type of rotational speed information to generate the function mapping table.

5. The method for controlling noise of a rotating device according to claim 3, wherein:
before the searching the predefined rotational speed mapping table according to the signal feature of the noise to obtain the rotational speed information, the method comprises:
adjusting the rotational speed of the rotating device through a rotation control device; and
obtaining a signal feature of the noise subject to each type of rotational speed information through the reference sensor to generate the rotational speed mapping table.

6. The method for controlling noise of a rotating device according to claim 3, wherein:
the signal feature comprises a signal strength feature or spectrum feature.

7. The method for controlling noise of a rotating device according to claim 1, wherein:
the rotating device comprises a fan, and the rotational speed information comprises the number of rotation times in a unit time; or
the rotating device comprises a water pump, and the rotational speed information comprises the number of rotation times in a unit time.

8. A controller, comprising:
a signal obtaining module, configured to obtain a sound wave signal of noise generated by a rotating device, wherein the sound wave signal is fed back by a reference sensor;
a rotational speed obtaining module, configured to obtain rotational speed information of the rotating device;
a searching module, configured to search a predefined function mapping table according to the rotational speed information to obtain transfer functions;
a first generating module, configured to generate a sound emitting command according to the transfer functions and the sound wave signal; and
a sending module, configured to send the sound emitting command to a secondary source emitting device, the secondary source emitting device being configured to emit a secondary sound wave, wherein the secondary sound wave is suppressing the noise generated by the rotating device.

9. The controller according to claim 8, wherein the rotational speed obtaining module comprises:
a receiving unit, configured to receive a rotational speed adjustment signal sent by a rotation control device, wherein the rotation control device uses the rotational speed adjustment signal to control the rotating device to adjust the rotational speed; and
a first obtaining unit, configured to obtain the rotational speed information according to the rotational speed adjustment signal.

10. The controller according to claim 8, wherein the rotational speed obtaining module comprises:
a second obtaining unit, configured to obtain a signal feature of a target noise according to the sound wave signal fed back by the reference sensor; and
a third obtaining unit, configured to search a predefined rotational speed mapping table according to the signal feature of the target noise to obtain the rotational speed information.

11. The controller according to claim 8, further comprising:
a second generating module, configured to obtain transfer functions corresponding to each type of rotational speed information of the rotating device to generate the function mapping table that comprises the rotational speed information and the transfer functions corresponding to the rotational speed information.

12. The controller according to claim 10, further comprising:
a third generating module, configured to generate, according to the signal feature of noise subject to each type of rotational speed information of the rotating device, the rotational speed mapping table that comprises the rotational speed information and the signal feature corresponding to the rotational speed information, wherein the signal feature of the noise obtained by the reference sensor.

13. The controller according to claim 9, wherein:
the rotation control device is integrated with the controller.
